(19) United States
(12) Patent Application Publication
(10) Pub. No.: US 2021/0121719 A1
(43) Pub. Date: Apr. 29, 2021

(54) MOUNTING SYSTEM FOR RESPIRATORY DEVICE

(71) Applicant: RPB Safety, LLC, Royal Oak, MI (US)

(72) Inventors: Garth Ivory, Bloomfield Hills, MI (US); Edward S. M. Williams, Christchurch (NZ); James A. Te Aika, Christchurch (NZ); William C. Hamill, Troy, MI (US)

(21) Appl. No.: 17/076,439

(22) Filed: Oct. 21, 2020

Related U.S. Application Data
(60) Provisional application No. 62/925,625, filed on Oct. 24, 2019.

(51) Int. Cl. A62B 9/04; F16B 5/06; A45F 5/02; A45F 3/14

(52) U.S. Cl. CPC A62B 9/04; F16B 5/0621; F16M 13/02; A45F 3/14; A45F 5/02

(57) ABSTRACT

A respiratory protective device comprises a housing that defines a chamber for containing tubing to provide clean air. Securing equipment is attachable to a user of the respiratory protective device. A mounting plate is disposed on a center axis and coupled to the housing for securing the housing to the securing equipment. The mounting plate is coupled to the housing via an interlocking connection to allow the housing to rotate relative to the mounting plate between an unlocked position and a locked position. In the locked position, the housing is generally perpendicular relative to the center axis.

### CROSS-REFERENCE TO RELATED APPLICATIONS

This application claims the benefit of U.S. Provisional Application Patent Ser. No. 62/925,625, filed on Oct. 24, 2019, the entire disclosure of which is hereby incorporated herein by reference in its entirety.

### BACKGROUND OF THE INVENTION

### 1. Field of the Invention

The present invention generally relates to a mounting system for a respiratory device.

### 2. Description of the Prior Art

Respiratory protective equipment is generally known in the art for providing breathable air to a user's breathing zone in a hazardous environment. Typically, the respiratory protective equipment is secured to the user's waist, allowing the user to work with both hands. Conventional respiratory protective equipment includes a housing containing tubing that supplies the user with clean air. A mounting plate on the securing equipment secures the housing to the securing equipment.

### SUMMARY OF THE INVENTION

The present invention provides respiratory protective equipment a secure connection for maintaining a desired position and preventing inadvertent removal of the respirator. The present invention also provides at least one locking member that has a simple design for easy attachment. In addition, the shape of the present invention provides flexibility for the location that the respiratory protective equipment is mounted, as well as the manner that it is mounted. Further, the present invention allows for easily changing the respiratory protective equipment between various locations on a user.

It is one aspect of the present invention to provide a respiratory protective device. The respiratory protective device comprises a housing that defines a chamber for containing tubing to provide clean air. Securing equipment is attachable to a user of the respiratory protective device. A mounting plate is disposed on a center axis and coupled to the housing for securing the housing to the securing equipment. The mounting plate is coupled to the housing via an interlocking connection to allow the housing to rotate relative to the mounting plate between an unlocked position and a locked position. In the locked position, the housing is generally perpendicular relative to the center axis.

It is another aspect of the present invention to provide a respiratory protective device. The respiratory protective device comprises a housing that defines a chamber for containing tubing to provide clean air. Securing equipment is attachable to a user of the respiratory protective device. A mounting plate is disposed on a center axis and coupled to the housing for securing the housing to the securing equipment. The mounting plate is coupled to the housing via an interlocking connection to allow the housing to rotate relative to the mounting plate between an unlocked position and a locked position. In the locked position, the housing is generally perpendicular relative to the center axis. The housing includes a bracket that extends outwardly from a back surface of the housing. The mounting plate includes at least one locking member for engaging the bracket thereby defining the interlocking connection and allowing the housing to rotate between the unlocked position and the locked position.

### BRIEF DESCRIPTION OF THE DRAWINGS

Other advantages of the present invention will be readily appreciated, as the same becomes better understood by reference to the following detailed description when considered in connection with the accompanying drawings wherein:

FIG. 1 is a back-perspective view of a respiratory protective device according to one embodiment of the present invention;

FIG. 2 is a perspective view of a mounting plate of the respiratory protective device;

FIG. 3 is a back-perspective view of a housing of the respiratory protective device; and

FIG. 4 is a back-perspective view of the respiratory protective device showing the mounting plate engaging the housing for rotation from an unlocked position into a locked position.

### DESCRIPTION OF THE ENABLING EMBODIMENT

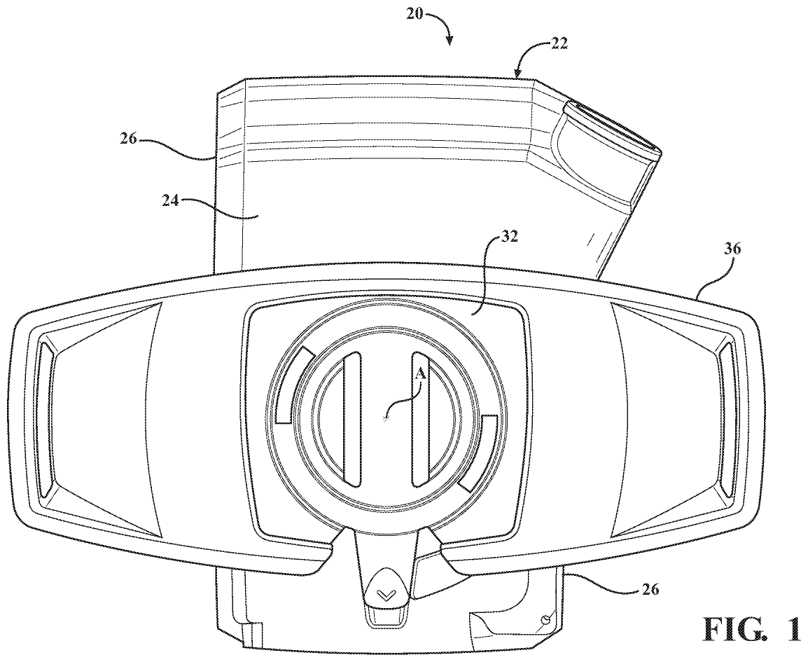

Referring to the Figures, wherein like numerals indicate corresponding parts throughout the several views, a respiratory protective device 20 constructed in accordance with one embodiment of the present invention is generally shown in FIG. 1. Typically, the respiratory protective device 20 mounts to the securing equipment, such as a belt or back harness (not shown) and supplies clean air.

As best illustrated in FIG. 1, the respiratory protective device 20 includes a housing 22 with a generally rectangular shape. The housing 22 has a front surface, a back surface 24, and a plurality of side surfaces 26. The plurality of side surfaces 26 connect the back surface 24 and the front surface forming a chamber extending between the back surface 24, the front surface, and the plurality of side surfaces 26. A mounting plate 32 extends along a center axis A and couples to the housing 22 for retaining, or securing, the housing 22 to the securing equipment, such as the belt (not shown) and a belt pad 36. The mounting plate 32 is coupled to the housing 22 via an interlocking connection allowing the housing 22 to rotate relative to the mounting plate 32 between an unlocked position and a locked position. In the locked position, the housing 22 is generally perpendicular relative to the center axis A. In other words, the interlocking connection is located between the housing 22 and the mounting plate 32 interconnecting the mounting plate 32 and the housing 22. It should be appreciated that the housing 22 and the mounting plate 32 may be formed by injection molding.

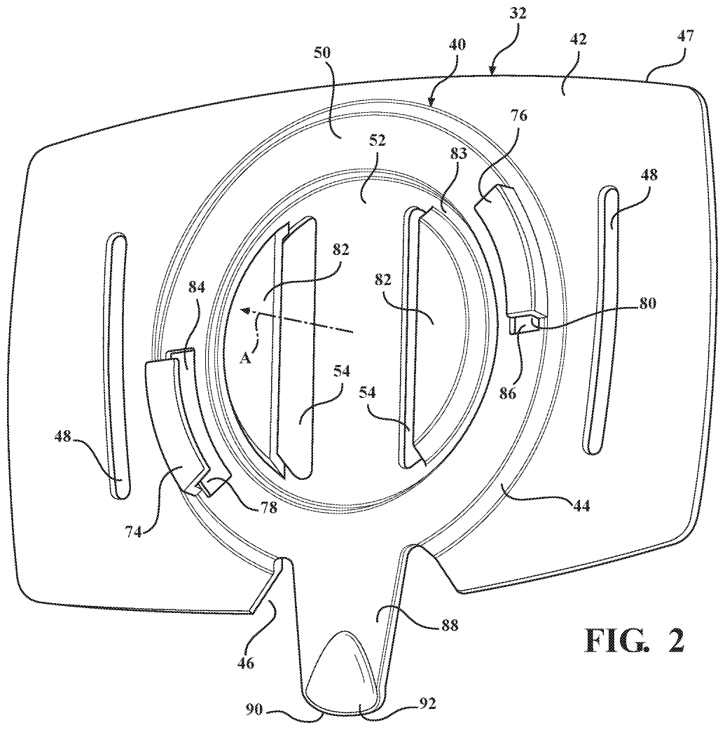

As best illustrated in FIG. 2, the mounting plate 32 includes a central portion 40 and a base portion 42, with the central portion 40 having a generally circular shape and being disposed on the center axis A, and the base portion 42 being axially spaced from the central portion 40 and having a generally flat shape. An intermediate portion 44 extends outwardly from the base portion 42 along the center axis A connecting the central portion 40 and the base portion 42. The mounting plate 32 defines a gap 46 extending from a periphery 47 of the base portion 42 toward the center axis A to the central portion 40. The mounting plate 32 defines a pair of slots 48 for possible reception of a portion of the securing equipment such as the belt or the belt pad 36. The central portion 40 includes an outer plate 50 and an inner plate 52, each having a generally circular shape, with the inner plate 52 being spaced axially inwardly from the outer plate 50. The inner plate 52 defines a pair of recesses 54, each having a D-shape, for receiving the strap or belt (not shown).

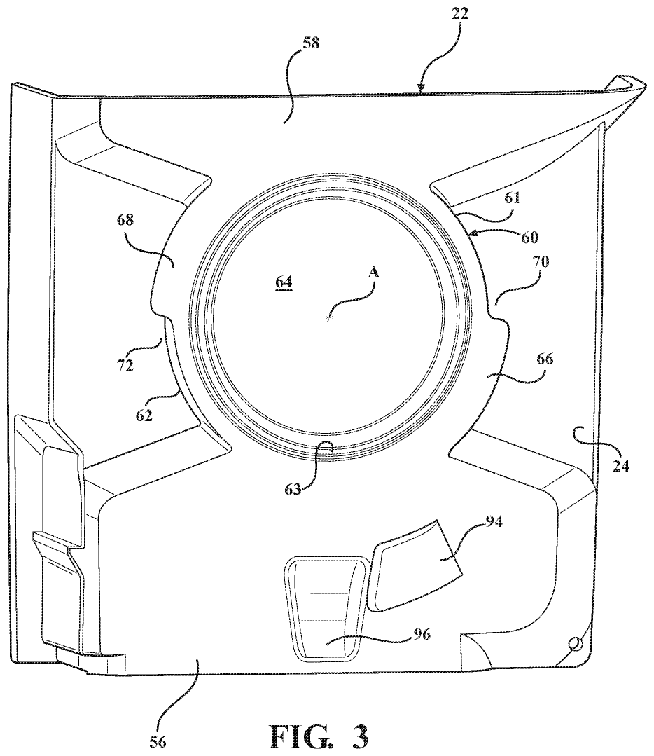

As best illustrated in FIG. 3, a first raised portion 56, a second raised portion 58, and the bracket 60 are unitary with the housing 22, with the bracket 60 extending between said first raised portion 56 and said second raised portion 58. The bracket 60 includes a first outer wall 61 and a second outer wall 62, each having a semi-arcuate shape and extending between the first raised portion 56 and the second raised portion 58 generally about the center axis A. A distance between the first outer wall 61 and the center axis A may be greater adjacent the second raised portion 58 than adjacent the first raised portion 56, and may increase from adjacent the second raised portion 58 to adjacent the first raised portion 56. A distance between the second outer wall 62 and the center axis A may be greater adjacent the first raised portion 56 than adjacent the second raised portion 58, and may increase from adjacent the first raised portion 56 to adjacent the second raised portion 58. A ridge 63, having an annular or circular shape, is used to locate the mounting plate 32 and extends outwardly from the bracket 60 and about the center axis A defining an indentation 64 extending radially inwardly from the ridge 63. The ridge 63 may be concentric with the central axis A and assists in locating the mounting plate 32 on the housing 22 and strengthening the connection between the two parts. The bracket 60 may include two or more attachment features that extend outwardly from a back surface 24 of the housing 22. A pair of flanges 66, 68 including a first flange 66 and a second flange 68 spaced circumferentially from one another, extend between the housing 22 and the mounting plate 32 in the locked position and, in some embodiments, extend radially outwardly from the bracket 60. The first flange 66 may extend radially outwardly from the first raised portion 56 defining a first groove 70 extending between the first flange 66 and the second raised portion 58. The second flange 68 may extend radially outwardly from the second raised portion 58 defining a second groove 72 extending between the second flange 68 and the first raised portion 56. In one arrangement, the first flange 66 and the second flange 68 are located diametrically opposite of one another on the bracket 60 and extend along the bracket 60.

As best illustrated in FIGS. 2 and 3, at least one locking member 74, 76 extends outwardly from the mounting plate 32 for engaging the bracket 60 thereby defining the interlocking connection and allowing the housing 22 to rotate between the unlocked position and the locked position.

A pair of hooks 74, 76 including a first hook 74 and a second hook 76, each having an L-shaped cross-section and spaced circumferentially from one another, extends axially outwardly between the mounting plate 32 and the housing 22 for engaging the pair of flanges 66, 68 in the locked position. The first hook 74 may extend outwardly from the mounting plate 32 and parallel to the center axis A defining a first receptacle 78. The second hook 76 may extend outwardly from the mounting plate 32 and parallel to the center axis A defining a second receptacle 80. In other words, the first hook 74 and the second hook 76 may be disposed diametrically opposite to one another on the outer plate 50. The mounting plate 32 is rotatable about the center axis A into the locked position, wherein the pair of flanges 66, 68 engage the pair of hooks 74, 76 to secure the mounting plate 32 to the housing 22. In other words, when the mounting plate 32 is in the locked position, the first flange 66 is disposed in the first receptacle 78, and the second flange 68 is disposed in the second receptacle 80 to form the bayonet connection between the mounting plate 32 and the housing 22. It should be appreciated from the drawings that because the distance between the center axis A and the outer walls 61, 62 may increase adjacent the pair of flanges 66, 68, the pair of hooks 74, 76 may engage the outer walls 61, 62 to cause the mounting plate 32 to tighten as it is moved into the locked position. For example, the portion of each of the pair of hooks 74, 76 that is perpendicular to the center axis A may contact the outer walls 61, 62 underneath the pair of flanges 66, 68.

A pair of locators 82, each having a semi-circular shape and spaced from one another, extend outwardly from the mounting plate 32 for engaging the bracket 60. In particular, the pair of locators 82 extends from the inner plate 52 along the center axis A adjacent the pair of recesses 54. The mounting plate 32 defines a locating groove 83 extending circumferentially around the pair of locators 82 for mating engagement with the ridge 63 to align and strengthen the interlocking connection.

The mounting plate 32 defines a pair of openings 84, 86, each having an arcuate shape and spaced circumferentially from one another, located on the mounting plate 32 adjacent to the pair of hooks 74, 76 for viewing the pair of flanges 66, 68 in the locked position. The pair of openings includes a first opening 84 and a second opening 86, each disposed on the outer plate 50, with the first opening 84 disposed adjacent the first hook 74 and the second opening 86 disposed adjacent the second hook 76 for viewing the first flange 66 and the second flange 68 in the locked position. A tab 88 extends radially outwardly from the mounting plate 32 for locking into a notch 96 on the housing 22. The end 90 of the tab 88 defines a protrusion 92 extending toward the base portion 42 for receiving a lifting force to ramp or deflect the tab 88 away from the back surface 24. A stop 94, extends outwardly from the housing 22 for securing the tab 88 in the locked position. The housing 22 defines the notch 96, disposed adjacent the stop 94, with the notch 96 extending inwardly from the back surface 24 into the housing 22 for allowing the tab 88 to deflect into the housing 22 and to provide access to the tab 88 in the locked position. The stop 94 and the notch 96 are disposed on the first raised portion 56. The stop 94 may ramp outwardly away from the housing 22 to allow the tab 88 to gradually traverse the stop 94. It should be appreciated that the notch 96 and the tab 88 may have transposable functions. In other words, in one embodiment, the tab 88 extends outwardly from said housing 22 and the mounting plate 32 defines the notch 96 for receiving the tab 88 to secure the mounting plate 32 to the bracket 70 in the locked position.

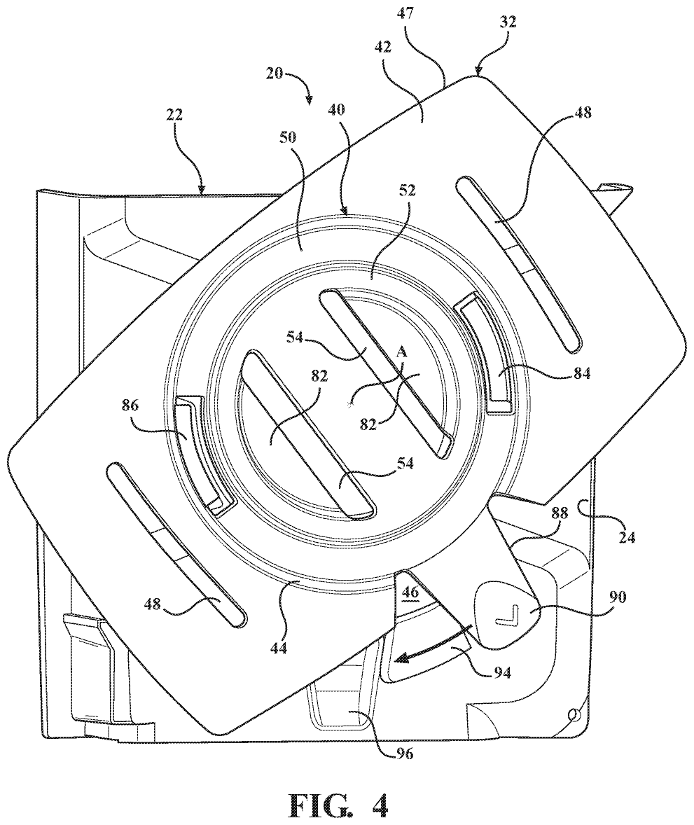

As best illustrated in FIG. 4, to secure the mounting plate 32 to the housing 22 and achieve the locked position, the pair of locators 82 engages the indentation 64 while the first hook 74 is disposed in the first groove 70 and the second hook 76 is disposed in the second groove 72. The ridge 63 is used to locate with the angled surface that spans between the outer plate 50 and the inner plate 52. The mounting plate 32 is then rotated clockwise about the center axis A. As the pair of hooks 74, 76 begin to engage the pair of flanges 66, 68, the lifting force is applied to the end 90 of the tab 88, and the tab 88 is deflected away from the housing 22 and is ramped or deflected over the stop 94 to allow the mounting plate 32 to continue rotating. Once the tab 88 has traversed the stop 94, the tab 88 rests against the back surface 24 with the protrusion 92 disposed adjacent the notch 96 and the pair of hooks 74, 76 fully engaging the pair of flanges 66, 68. Although the mounting plate 32 covers the bracket 60 in the locked position, the pair of flanges 66, 68 is viewable via the pair of openings 84, 86 to verify the locked position.

The respiratory protective device 20 can be attached to various securing equipment. The respiratory protective device 20 can be attached to a user's waist in a belt configuration, secured around the user's shoulders in a back-harness configuration, attached to a work station, attached to the inside of a vehicle in a wall bracket configuration. For example, the respiratory protective device 20 may be mounted centrally on a user's lumbar spine or centrally on a user's thoracic spine.

It should be appreciated that the simple design of the interlocking connection allows for the respiratory protective device 20 to easily transition between one piece of securing equipment to another. It should also be appreciated that the interlocking connection may require no additional fasteners or screws, thus allowing for a quick disconnect and easy cleaning of the respiratory protective device 20. In addition, the generally flat, one-piece mounting plate 32 and the generally flat housing 22 may be easily wiped down, assisting in leaving a contaminated area in a controlled manner. Furthermore, the lack of cavities on the mounting plate 32 and the housing 22 may assist in decontaminating the respiratory protective device 20. When the respiratory protective device 20 is secured to the user, the housing 22 maintains a desired position relative to the user. To unlock the mounting plate 32 from the housing 22, the housing 22 is rotated about the center axis A and the tab 88 is deflected over the stop 94.

Obviously, many modifications and variations of the present invention are possible in light of the above teachings and may be practiced otherwise than as specifically described while within the scope of the appended claims. These antecedent recitations should be interpreted to cover any combination in which the inventive novelty exercises its utility. The use of the word “said” in the apparatus claims refers to an antecedent that is a positive recitation meant to be included in the coverage of the claims whereas the word “the” precedes a word not meant to be included in the coverage of the claims.

What is claimed is:

1. A respiratory protective device comprising:
a housing defining a chamber for containing tubing to provide clean air;
securing equipment attachable to a user of said respiratory protective device;
a mounting plate disposed on a center axis and coupled to said housing for securing said housing to said securing equipment; and
said mounting plate being coupled to said housing via an interlocking connection allowing said housing to rotate relative to said mounting plate between an unlocked position and a locked position whereby, in said locked position, said housing is generally perpendicular relative to said center axis.

2. The respiratory protective device as set forth in claim 1 wherein said interlocking connection is a bayonet connection located between said housing and said mounting plate.

3. The respiratory protective device as set forth in claim 1 wherein said housing includes a bracket extending outwardly from a back surface of said housing; and
said mounting plate including at least one locking member for engaging said bracket thereby defining said interlocking connection and allowing said housing to rotate between said unlocked position and said locked position.

4. The respiratory protective device as set forth in claim 3 further including a tab extending radially outwardly from said mounting plate for rotating said mounting plate into said locked position.

5. The respiratory protective device as set forth in claim 1 further including a pair of flanges, each having an arcuate shape and spaced circumferentially from one another, extending between said housing and said mounting plate in said locked position; and
wherein said at least one locking member is a pair of hooks, each having an L-shaped cross-section and spaced circumferentially from one another, extending axially outwardly between said mounting plate and said housing for engaging said pair of flanges in said locked position.

6. The respiratory protective device as set forth in claim 1 wherein said interlocking connection does not include any screws or rivets and wherein said mounting bracket is unitary.

7. The respiratory protective device as set forth in claim 4 wherein said securing equipment includes a belt, a pad, a harness, or a wall bracket.

8. The respiratory protective device as set forth in claim 4 further including a stop extending outwardly from said housing for securing said tab in said locked position.

9. The respiratory protective device as set forth in claim 8 wherein said housing defines a notch, disposed adjacent said stop, extending inwardly from said back surface into said housing for allowing said tab to deflect into said housing and to provide access to said tab in said locked position.

10. The respiratory protective device as set forth in claim 4 further including an end extending outwardly from said tab defining a protrusion for receiving a lifting force to deflect said tab away from said back surface.

11. The respiratory protective device as set forth in claim 3 further including a pair of locators, each spaced from one another, extending outwardly from said mounting plate for engaging said bracket in said locked position.

12. The respiratory protective device as set forth in claim 4 further including a pair of openings, each spaced circumferentially from one another, located on said mounting plate adjacent to said pair of hooks for viewing said pair of flanges in said locked position.

13. The respiratory protective device as set forth in claim 5 wherein each of said pair of hooks engages an outer wall of said bracket in said locked position to tighten said interlocking connection in said locked position.

14. The respiratory protective device as set forth in claim 12 further including a ridge having a circular shape extending outwardly from said bracket; and
said mounting plate defining a locating groove for mating engagement with said ridge to align and strengthen said interlocking connection.

15. A respiratory protective device comprising:
a housing defining a chamber for containing tubing to provide clean air;
securing equipment attachable to a user of said respiratory protective device;
a mounting plate disposed on a center axis and coupled to said housing for securing said housing to said securing equipment;
said mounting plate being coupled to said housing via an interlocking connection allowing said housing to rotate relative to said mounting plate between an unlocked position and a locked position whereby, in said locked position, said housing is generally perpendicular relative to said center axis;
said housing including a bracket extending outwardly from a back surface of said housing; and
said mounting plate including at least one locking member for engaging said bracket thereby defining said interlocking connection and allowing said housing to rotate between said unlocked position and said locked position.

16. The respiratory protective device as set forth in claim 15 wherein said interlocking connection is a bayonet connection located between said housing and said mounting plate.

17. The respiratory protective device as set forth in claim 15 wherein said mounting plate includes a tab extending radially outwardly from said mounting plate for rotating said mounting plate into said locked position.

18. The respiratory protective device as set forth in claim 17 further including a pair of flanges, each having an arcuate shape and spaced circumferentially from one another, extending radially outwardly from said bracket; and
wherein said locking member including a locking member is a pair of hooks, each having an L-shaped cross-section and spaced circumferentially from one another, extend axially outwardly from said mounting plate for engaging said pair of flanges.

19. The respiratory protective device as set forth in claim 17 further including a stop extending outwardly from said housing for securing said tab in said locked position.

20. The respiratory protective device as set forth in claim 15 further including a tab extending outwardly from said housing; and
said mounting plate defining a notch for receiving said tab to secure said mounting plate to said bracket in said locked position.
